(19) United States
(12) Patent Application Publication
(10) Pub. No.: US 2018/0202617 A1
(43) Pub. Date: Jul. 19, 2018

(54) MULTIFUNCTIONAL WORKING LIGHT

(71) Applicant: ZHIHUI HE, Ningbo (CN)

(72) Inventor: XUEFENG ZHU, NINGBO (CN)

(73) Assignee: ZHIHUI HE

(21) Appl. No.: 15/922,911

(22) Filed: Mar. 16, 2018

Related U.S. Application Data
(63) Continuation of application No. PCT/CN2016/079461, filed on Apr. 15, 2016.

(30) Foreign Application Priority Data
Oct. 27, 2015 (CN) 201520842427.6

(51) Int. Cl. F21L 4/02; F21V 17/12; F21V 21/096; F21V 21/40; F21V 21/092; F21V 23/04; F21L 4/08

(52) U.S. Cl. CPC F21L 4/02; F21V 17/12; F21V 21/096; F21V 3/02; F21V 21/092; F21V 23/0414; F21L 4/08; F21V 21/40

(57) ABSTRACT

The present invention relates to a multifunctional working light, comprising a light tube and a light-emitting plate. The light-emitting plate is installed in the light tube. One end of the light tube is axially rotatably connected with a rotating sleeve. The end connected with the rotating sleeve is axially connected with a handle body. A fixed rocker arm is rotatably connected to a side wall of the handle body. Suction magnets are installed on an end surface of a free end of the fixed rocker arm. A hook is installed in the side wall of the handle body. A lower end of the hook is connected with the handle body through a ball body. The other end of the light tube is axially connected with a connecting sleeve.

### CROSS-REFERENCE TO RELATED APPLICATIONS

This application is a continuation of International Patent Application No. PCT/CN2016/079461 with a filing date of Apr. 15, 2016, designating the United States, now pending, and further claims priority to Chinese Patent Application No. 201520842427.6 with a filing date of Oct. 27, 2015. The content of the aforementioned applications, including any intervening amendments thereto, are incorporated herein by reference.

### TECHNICAL FIELD

The present invention relates to the field of working lights, and particularly relates to a multifunctional working light. The working light can be divided into two independent small working lights which can be spliced into a large working light.

### BACKGROUND OF THE PRESENT INVENTION

With the development of science and technology, there are more and more illuminating lights for people, and use frequency of the working lights is also higher and higher. The working lights are required to be used in many occasions, such as overhauling of equipment, vehicle repair and emergency moments. Therefore, requirements for the working lights are higher and higher. The working lights are required to realize simple and convenient installation and placement and to regulate an illuminating direction at any time.

### SUMMARY OF PRESENT INVENTION

A technical problem to be solved by the present invention is to provide a multifunctional working light. The multifunctional working light has a novel structure and a beautiful appearance, enables splicing combination and separated usage, and can be conveniently installed and placed. A light source can be conveniently adjusted.

A technical solution adopted for solving the technical problems by the present invention is as follows: a multifunctional working light is provided, comprising a light tube and a light-emitting plate. The working light can be divided into two independent small working lights which can be spliced into a large working light. The light-emitting plate is installed in the light tube. One end of the light tube is axially rotatably connected with a rotating sleeve. The end connected with the rotating sleeve is axially connected with a handle body. A fixed rocker arm is rotatably connected to a side wall of the handle body. Suction magnets are installed on an end surface of a free end of the fixed rocker arm. A hook is installed in the side wall of the handle body. A lower end of the hook is connected with the handle body through a ball body. The other end of the light tube is axially connected with a connecting sleeve. A magnetic board is installed in the connecting sleeve.

As a supplement to the present invention, each of the handle body and the fixed rocker arm is formed by splicing half housings.

As a preferred solution of the present invention, a control board and a switch board connected with the control board are installed in the handle body, and the switch board is connected with a button installed on a side wall of the handle body.

Preferably, one end of each of two half housings of the fixed rocker arm is respectively connected with two rotating shafts installed in the handle body; an end surface of one end of the two rotating shafts is respectively embedded into a gear-shaped inner hole in a center of each of two fixing plates in the handle body; and a radial bulge of one end of the rotating shafts is embedded into an edge sawtooth of the gear-shaped inner hole.

Further, a rechargeable battery is installed on a lower end surface of the light-emitting plate; and a charging jack connected with the control board is formed in the side wall of the handle body.

Further, a magnetic board installing seat is connected in the connecting sleeve through a shaft sleeve; and the magnetic board is installed in the magnetic board installing seat and is covered through a cover board.

Further, a decorative buckle plate is installed on a side wall of one side provided with the button on the side wall of the handle body.

Further, suction cover boards are installed on an end surface of a free end of the fixed rocker arm; and a plurality of suction magnets are installed uniformly on the suction cover boards.

The present invention relates to a multifunctional working light. The multifunctional working light has a novel structure and a beautiful appearance, enables splicing combination and separated usage, and can be conveniently installed and placed. A light source can be conveniently adjusted.

Splicing combination and separated usage can be realized according to different use environments. The separated working lights can be independently used. The size of each separated working light is only half of the working light before separating, so use is more flexible and convenient.

### DESCRIPTION OF THE DRAWINGS

FIG. 1 is an exploded three-dimensional structural diagram of the present invention;

FIG. 2 is a structural diagram of a use state of the present invention; and

FIG. 3 is a structural diagram of a use state of the present invention.

### DETAILED DESCRIPTION OF PREFERRED EMBODIMENTS

The present invention is further described below in combination with specific embodiments. It should be understood that these embodiments are only used to illustrate the present invention, not to limit a scope of the present invention. In addition, it should be understood that after contents instructed by the present invention are read, various changes or modifications can be made to the present invention by those skilled in the art, and these equivalent forms also fall within a scope defined by claims appended in the present application.

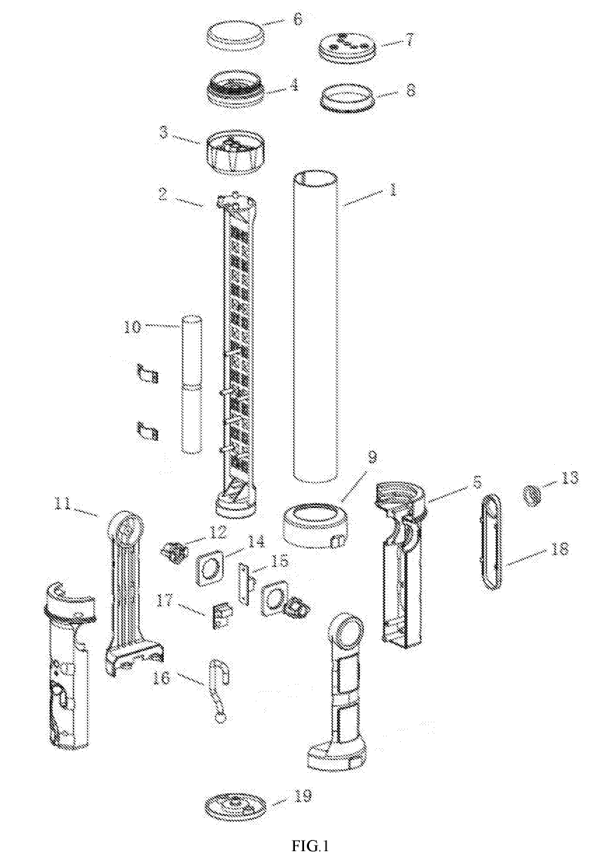

As shown in FIGS. 1-3, an embodiment of the present invention relates to a multifunctional o working light. The working light can be divided into two independent small working lights which can be spliced into a large working light. The working light comprises a light tube 1 and a light-emitting plate 2. The light-emitting plate 2 is installed in the light tube 1. One end of the light tube 1 is axially rotatably connected with a rotating sleeve 9. The end connected with the rotating sleeve 9 is axially connected with a handle body 5. A fixed rocker arm 11 is rotatably connected to a side wall of the handle body 5. Suction magnets are installed on an end surface of a free end of the fixed rocker arm 11. A hook 16 is installed in the side wall of the handle body 5. A lower end of the hook 16 is connected with the handle body 5 through a ball body. The other end of the light tube 1 is axially connected with a connecting sleeve 3. A magnetic board 7 is installed in the connecting sleeve 3.

In a normal state, the fixed rocker arm 11 and the handle body 5 are arranged in the same direction, and the fixed rocker arm 11 is sleeved on an outer side of the handle body 5. Since suction magnets are installed on an end surface of a free end of the fixed rocker arm 11, when the fixed rocker arm 11 rotates to be perpendicular to the handle body 5, the fixed rocker arm 11 is absorbed to a roof or wall of a strip steel structure to keep the light tube 1 in a horizontal state.

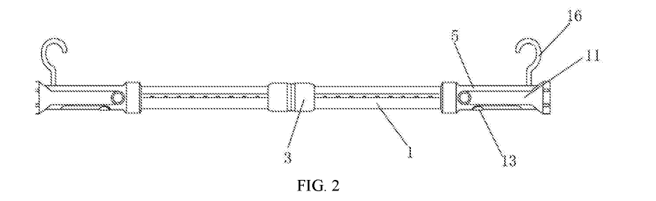

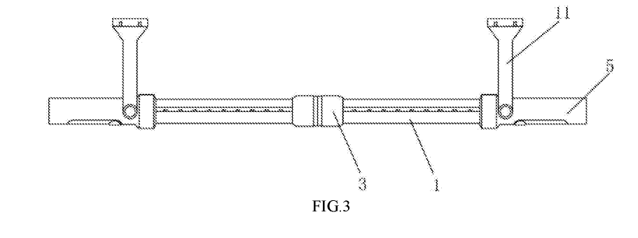

As shown in FIG. 3, one end of each of two working lights is spliced; the magnetic board 7 is sucked together; then the fixed rocker arms 11 of the two working lights are simultaneously absorbed to the roof or wall of the strip steel structure; and in this way, illuminating brightness is large and is firm. Similarly, as shown in FIG. 2, the hook 16 on the working light is pulled out so that the hook 16 is perpendicular to the handle body 5 and can be hanged anywhere, thereby ensuring convenient installation.

As a supplement to the present invention, each of the handle body 5 and the fixed rocker arm 11 is formed by splicing half housings, thereby realizing convenient assembly and disassembly.

As a preferred solution of the present invention, a control board 17 and a switch board 15 connected with the control board 17 are installed in the handle body 5, and the switch board 15 is connected with a button 13 installed on a side wall of the handle body 5, so that use is convenient and the switch of the light-emitting plate 2 is conveniently controlled.

Preferably, one end of each of two half housings of the fixed rocker arm 11 is respectively connected with two rotating shafts 12 installed in the handle body 5; an end surface of one end of the two rotating shafts 12 is respectively embedded into a gear-shaped inner hole in a center of each of two fixing plates 14 in the handle body 5; and a radial bulge of one end of the rotating shafts 12 is embedded into an edge sawtooth of the gear-shaped inner hole, so that certain resistance is generated during rotation of the fixed rocker arm 11 to prevent the fixed rocker arm 11 from rotating independently during absorbing.

Further, a rechargeable battery 10 is installed on a lower end surface of the light-emitting plate 2; and a charging jack connected with the control board 17 is formed in the side wall of the handle body 5, so that charging of the rechargeable battery 10 is convenient without replacing the battery.

Further, a magnetic board installing seat 4 is connected in the connecting sleeve 3 through a shaft sleeve 8; and the magnetic board 7 is installed in the magnetic board installing seat 4 and is covered through a cover board 6, so that the magnetic board 7 is protected and the two working lights can be conveniently spliced.

Further, a decorative buckle plate 18 is installed on a side wall of one side provided with the button 13 on the side wall of the handle body 5, thereby increasing aesthetics of appearance.

Further, suction cover boards 19 are installed on an end surface of a free end of the fixed rocker arm 11; and a plurality of suction magnets are installed uniformly on the suction cover boards 19, so that the suction magnets are exposed outside to facilitate absorbing.

The working light of the present invention has a novel structure and a beautiful appearance, enables splicing combination and separated usage, and can be conveniently installed and placed. The light source can be conveniently adjusted.

### INDUSTRIAL APPLICABILITY

After splicing combination, the magnets on both ends of the handle body can be absorbed to a metal surface for use. For example, the magnets are absorbed to a lower part of an automobile hood for illumination, and an angle of the light source can be adjusted. The magnets can also be fixed in a proper place through a hook in the handle body for use. After separated, the working light becomes two working lights with the size of half of the working light before separating, so the working light can be used in different environments more conveniently.

We claim:

1. A multifunctional working light, comprising a light tube (1) and a light-emitting plate (2), wherein the working light can be divided into two independent small working lights which can be spliced into a large working light; the light-emitting plate (2) is installed in the light tube (1); one end of the light tube (1) is axially rotatably connected with a rotating sleeve (9); the end connected with the rotating sleeve (9) is axially connected with a handle body (5); a fixed rocker arm (11) is rotatably connected to a side wall of the handle body (5); suction magnets are installed on an end surface of a free end of the fixed rocker arm (11); a hook (16) is installed in the side wall of the handle body (5); a lower end of the hook (16) is connected with the handle body (5) through a ball body; the other end of the light tube (1) is axially connected with a connecting sleeve (3); and a magnetic board (7) is installed in the connecting sleeve (3).

2. The multifunctional working light according to claim 1, wherein each of the handle body (5) and the fixed rocker arm (11) is formed by splicing half housings.

3. The multifunctional working light according to claim 1, wherein a control board (17) and a switch board (15) connected with the control board (17) are installed in the handle body (5), and the switch board (15) is connected with a button (13) installed on a side wall of the handle body (5).

4. The multifunctional working light according to claim 2, wherein one end of each of two half housings of the fixed rocker arm (11) is respectively connected with two rotating shafts (12) installed in the handle body (5); an end surface of one end of the two rotating shafts (12) is respectively embedded into a gear-shaped inner hole in a center of each of two fixing plates (14) in the handle body (5); and a radial bulge of one end of the rotating shafts (12) is embedded into an edge sawtooth of the gear-shaped inner hole.

5. The multifunctional working light according to claim 3, wherein a rechargeable battery (10) is installed on a lower end surface of the light-emitting plate (2); and a charging jack connected with the control board (17) is formed in the side wall of the handle body (5).

6. The multifunctional working light according to claim 1, wherein a magnetic board installing seat (4) is connected in the connecting sleeve (3) through a shaft sleeve (8); and the magnetic board (7) is installed in the magnetic board installing seat (4) and is covered through a cover board (6).

7. The multifunctional working light according to claim 3, wherein a decorative buckle plate (18) is installed on a side wall of one side provided with the button (13) on the side wall of the handle body (5).

8. The multifunctional working light according to claim 1, wherein suction cover boards (19) are installed on an end surface of a free end of the fixed rocker arm (11); and a plurality of suction magnets are installed uniformly on the suction cover boards (19).
